(19) United States
(12) Patent Application Publication
(10) Pub. No.: US 2026/0122648 A1
(43) Pub. Date: Apr. 30, 2026

(54) MODULATION SWITCHING FOR PHYSICAL DOWNLINK CONTROL CHANNEL

(71) Applicant: QUALCOMM Incorporated, San Diego, CA (US)

(72) Inventors: Pinar SEN, San Diego, CA (US); Wei YANG, San Diego, CA (US); Mahmoud TAHERZADEH BOROUJENI, San Diego, CA (US); Jing JIANG, San Diego, CA (US); Thomas Joseph RICHARDSON, South Orange, NJ (US); Gabi SARKIS, San Diego, CA (US)

(21) Appl. No.: 18/927,292

(22) Filed: Oct. 25, 2024

(51) Int. Cl. H04W 72/231; H04L 1/00; H04W 72/51

(52) U.S. Cl. CPC H04W 72/231; H04L 1/0004; H04L 1/0038; H04W 72/51

(57) ABSTRACT

Various aspects of the present disclosure generally relate to wireless communication. A network node may transmit a physical downlink control channel (PDCCH) communication to a user equipment (UE) using a type of modulation. Under some conditions, a statically configured modulation scheme may have sub-optimal performance with respect to network resources. Various aspects relate generally to modulation switching for PDCCH. Some aspects more specifically relate to switching from modulating a transmission using a default constellation size associated with a default code rate to modulating the transmission with a larger constellation size associated with a smaller code rate. In some examples, the described techniques can be used to improve performance, such as with respect to frequency resource utilization.

### FIELD OF THE DISCLOSURE

Aspects of the present disclosure generally relate to wireless communication and specifically relate to techniques, apparatuses, and methods associated with modulation switching for a physical downlink control channel.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

A network node may transmit a physical downlink control channel (PDCCH) communication to a user equipment (UE) using a type of modulation, such as quadrature amplitude modulation (QAM) or quadrature phase shift keying (QPSK), among other examples. Each type of modulation is associated with a constellation point, which is a representation of changes in a signal amplitude and a signal phase and which corresponds to a pattern of bits being conveyed by the signal. Different modulation schemes may have different quantities or arrangements of constellation points, which may allow for different amounts of information to be conveyed by the signal in each sample or symbol of the signal. Under some conditions, such as at differing channel delay spread values, aggregation levels, downlink control information (DCI) message sizes, or when using different quantities of antennas, a configured modulation scheme may have sub-optimal performance. For example, some modulation schemes may result in frequency resources being un-utilized during communication.

### SUMMARY

Some aspects described herein relate to a method for wireless communication by a user equipment (UE). The method may include receiving a physical downlink control channel (PDCCH) transmission. The method may include demodulating the PDCCH transmission in accordance with a modulation order and a code rate associated with one or more parameters of the PDCCH transmission, wherein the modulation order is associated with a larger constellation size than a default PDCCH modulation order and the code rate is associated with a smaller code rate than a default PDCCH code rate.

Some aspects described herein relate to a method of wireless communication performed by a network node. The method may include modulating a PDCCH transmission in accordance with a modulation order and a code rate associated with one or more parameters of the PDCCH transmission, wherein the modulation order is associated with a larger constellation size than a default PDCCH modulation order and the code rate is associated with a smaller code rate than a default PDCCH code rate. The method may include transmitting the PDCCH transmission.

Some aspects described herein relate to a UE for wireless communication. The UE may include a processing system that includes one or more processors and one or more memories coupled with the one or more processors. The processing system may be configured to cause the UE to receive a PDCCH transmission. The processing system may be configured to cause the UE to demodulate the PDCCH transmission in accordance with a modulation order and a code rate associated with one or more parameters of the PDCCH transmission, wherein the modulation order is associated with a larger constellation size than a default PDCCH modulation order and the code rate is associated with a smaller code rate than a default PDCCH code rate.

Some aspects described herein relate to a network node for wireless communication. The network node may include a processing system that includes one or more processors and one or more memories coupled with the one or more processors. The processing system may be configured to cause the network node to modulate a PDCCH transmission in accordance with a modulation order and a code rate associated with one or more parameters of the PDCCH transmission, wherein the modulation order is associated with a larger constellation size than a default PDCCH modulation order and the code rate is associated with a smaller code rate than a default PDCCH code rate. The processing system may be configured to cause the network node to transmit the PDCCH transmission.

Some aspects described herein relate to a non-transitory computer-readable medium that stores a set of instructions for wireless communication by an UE. The set of instructions, when executed by one or more processors of the UE, may cause the UE to receive a PDCCH transmission. The set of instructions, when executed by one or more processors of the UE, may cause the UE to demodulate the PDCCH transmission in accordance with a modulation order and a code rate associated with one or more parameters of the PDCCH transmission, wherein the modulation order is associated with a larger constellation size than a default PDCCH modulation order and the code rate is associated with a smaller code rate than a default PDCCH code rate.

Some aspects described herein relate to a non-transitory computer-readable medium that stores a set of instructions for wireless communication by a network node. The set of instructions, when executed by one or more processors of the network node, may cause the network node to modulate a PDCCH transmission in accordance with a modulation order and a code rate associated with one or more parameters of the PDCCH transmission, wherein the modulation order is associated with a larger constellation size than a default PDCCH modulation order and the code rate is associated with a smaller code rate than a default PDCCH code rate. The set of instructions, when executed by one or more processors of the network node, may cause the network node to transmit the PDCCH transmission.

Some aspects described herein relate to an apparatus for wireless communication. The apparatus may include means for receiving a PDCCH transmission. The apparatus may include means for demodulating the PDCCH transmission in accordance with a modulation order and a code rate associated with one or more parameters of the PDCCH transmission, wherein the modulation order is associated with a larger constellation size than a default PDCCH modulation order and the code rate is associated with a smaller code rate than a default PDCCH code rate.

Some aspects described herein relate to an apparatus for wireless communication. The apparatus may include means for modulating a PDCCH transmission in accordance with a modulation order and a code rate associated with one or more parameters of the PDCCH transmission, wherein the modulation order is associated with a larger constellation size than a default PDCCH modulation order and the code rate is associated with a smaller code rate than a default PDCCH code rate. The apparatus may include means for transmitting the PDCCH transmission.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example disaggregated network node architecture in accordance with the present disclosure.

FIG. 3 is a diagram illustrating an example of physical channels and reference signals in a wireless network, in accordance with the present disclosure.

FIGS. 4A-4E are diagrams illustrating an example associated with modulation switching for physical downlink control channel (PDCCH), in accordance with the present disclosure.

FIG. 5 is a flowchart illustrating an example process performed, for example, at a user equipment (UE) or an apparatus of an UE that supports modulation switching for PDCCH in accordance with the present disclosure.

FIG. 6 is a flowchart illustrating an example process performed, for example, at a network node or an apparatus of a network node that supports modulation switching for PDCCH in accordance with the present disclosure.

FIG. 7 is a diagram of an example apparatus for wireless communication that supports modulation switching for PDCCH in accordance with the present disclosure.

FIG. 8 is a diagram of an example apparatus for wireless communication that supports modulation switching for PDCCH in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A network node may transmit a physical downlink control channel (PDCCH) communication to a user equipment (UE) using a type of modulation. For example, the network node may modulate a signal using quadrature amplitude modulation (QAM), such as 4-QAM, 8-QAM, 16-QAM, 32-QAM, or 64-QAM, among other examples. Additionally or alternatively, the network node may modulate a signal using phase shift keying (PSK), such as binary phase shift keying (BPSK) or quadrature phase shift keying (QPSK), among other examples. Each type of modulation is associated with a set of constellation point, which may be collectively referred to as a modulation “constellation” or a “constellation map.” The modulation constellation is a representation of a changes in a signal amplitude and a signal phase and which corresponds to a pattern of bits being conveyed by the signal.

Different modulation schemes may have different quantities or arrangements of constellation points. For example, QPSK modulation may include a set of 4 constellation points in an in-phase and quadrature (IQ) domain, [00, 01, 10, 11]. In contrast, 16-QAM may include a set of 16 constellation points in the IQ domain, [0000, 0001, 0010, . . . , 1110, 1111]. With greater quantities of constellation points in a constellation, a network node may modulate more information into a single sample of a signal, which may correspond to a single symbol in a resource element (RE).

Under some conditions, a statically configured modulation scheme may have sub-optimal performance with respect to network resources. For example, a statically configured modulation scheme may have a sub-optimal usage of network resources at differing channel delay spread values, differing aggregation levels, or differing downlink control information (DCI) message sizes. Similarly, a statically configured modulation scheme may have sub-optimal performance when the network node is using different quantities of antennas for transmission or the UE is using different quantities of antennas for reception.

Various aspects relate generally to modulation switching for PDCCH. Some aspects more specifically relate to modulating a PDCCH transmission with a modulation order and constellation size that is associated with a code rate. For example, a network node may switch from modulating a transmission using a default constellation size associated with a default code rate to modulating the transmission with a larger constellation size associated with a smaller code rate. Additionally or alternatively, the network node may switch constellation sizes in connection with a DCI size, an aggregation level, a channel delay spread, or a quantity of antennas being used. Similarly, a UE may switch from demodulation using a default constellation size to demodulation using the larger constellation size. In some aspects, a maximum coded length for a PDCCH candidate modulated with a larger constellation size, such as 16-QAM, may be the same as a maximum coded length for the PDCCH candidate when modulated with a default constellation size, such as QPSK. In some aspects, the network node and/or the UE may select a modulation scheme (or demodulation scheme) in connection with a control resource set (CORESET), a search space or search space type, a DCI format, or a UE decoding capability.

Particular aspects of the subject matter described in this disclosure can be implemented to realize one or more of the following potential advantages. In some examples, the described techniques can be used to improve performance, such as with respect to frequency resource utilization. In some examples, by switching modulation schemes in connection with one or more factors, the described techniques can be used to improve error rate and signal to noise ratio (SNR). In some examples, by maintaining the same maximum coded length for different constellation sizes, the described techniques can be used to limit a quantity of blind detections by a UE when receiving the PDCCH.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

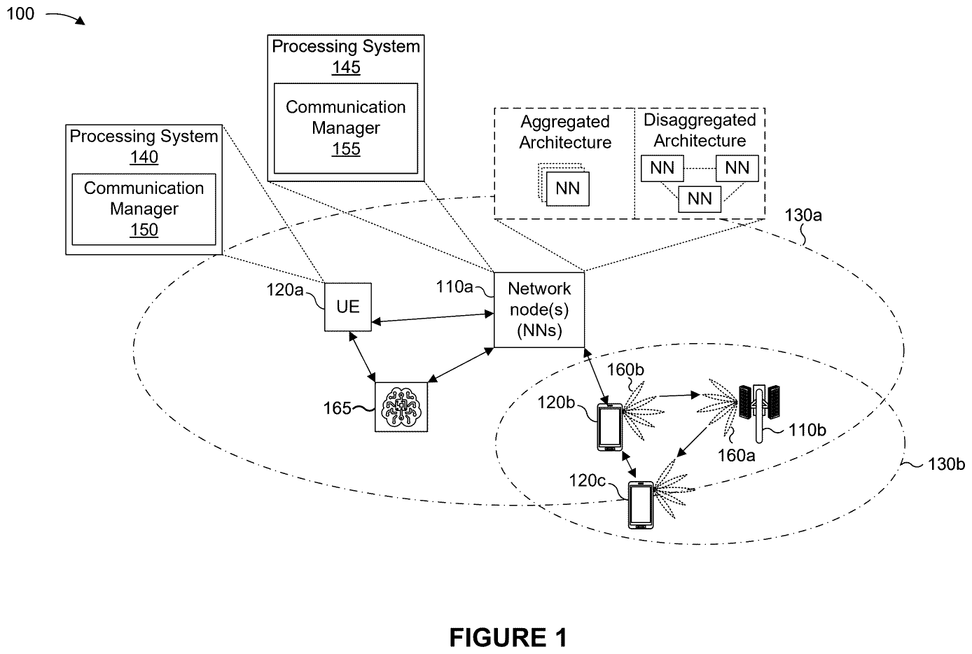

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on or otherwise associated with user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

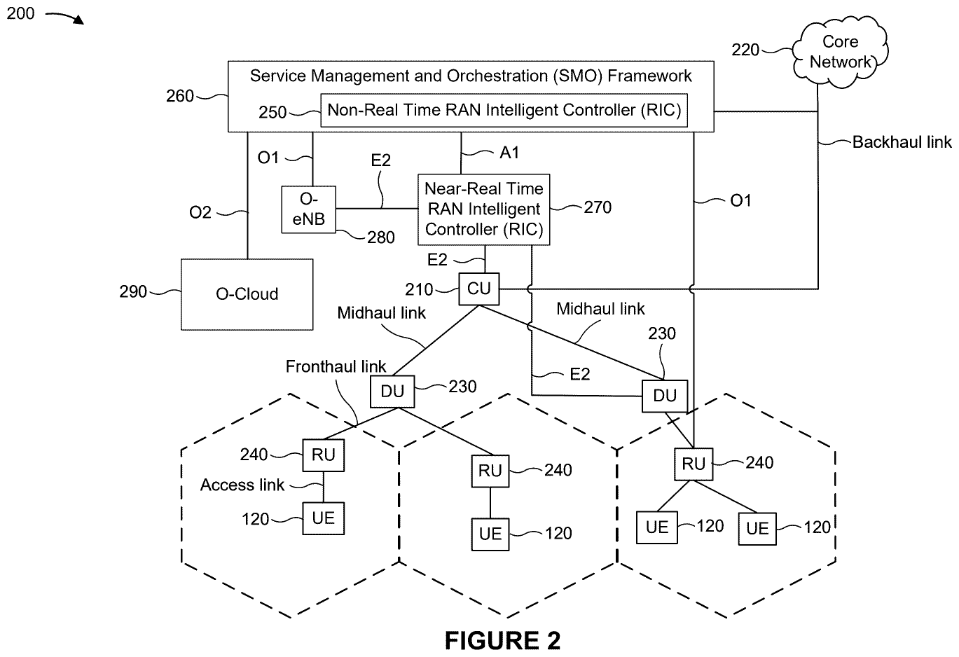

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, in accordance with a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move in accordance with the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified in accordance with different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) in accordance with changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In the wireless communication network 100, information may be represented as a sequence of binary bits that are mapped (for example, modulated) to an analog signal waveform that is transmitted to a receiver over a wireless communication channel. In some cases, however, the wireless communication channel may introduce errors that corrupt the transmitted signal due to random noise, interference, device impairments, and/or other factors. At the receiver, the received signal (that may have been corrupted during transmission) is mapped back to binary bits, with the received binary information estimating the transmitted binary information. Accordingly, because errors may corrupt the signal that is estimated at the receiver, channel coding or forward error correction (FEC) techniques are often used to control errors in data transmission over unreliable or noisy communication channels or otherwise mitigate the bit errors that may occur due to noise, interference, and/or other factors. For example, channel coding generally includes an encoding operation performed at a transmitter (for example, a first wireless device, which may be a UE 120 or a network node 110) and a decoding operation performed at a receiver (for example, a second wireless device, which may be a UE 120 or a network node 110). Channel coding is generally accomplished by selectively introducing redundancy into the transmitted information stream, typically using an error correction code (ECC), which allows the receiver to detect errors and/or correct bit errors in the received data stream and thereby provide more reliable information transmission. Accordingly, channel codes are often used in scenarios where retransmissions are undesirable and/or high transmission reliability is needed, such as downlink and/or uplink control channel communications.

In some aspects, the UE 120 may include a communication manager 150. As described in more detail elsewhere herein, the communication manager 150 may receive a PDCCH transmission; and demodulate the PDCCH transmission in accordance with a modulation order and a code rate associated with one or more parameters of the PDCCH transmission, wherein the modulation order is associated with a larger constellation size than a default PDCCH modulation order and the code rate is associated with a smaller code rate than a default PDCCH code rate. Additionally or alternatively, the communication manager 150 may perform one or more other operations described herein.

In some aspects, the network node 110 may include a communication manager 155. As described in more detail elsewhere herein, the communication manager 155 may modulate a PDCCH transmission in accordance with a modulation order and a code rate associated with one or more parameters of the PDCCH transmission, wherein the modulation order is associated with a larger constellation size than a default PDCCH modulation order and the code rate is associated with a smaller code rate than a default PDCCH code rate; and transmit the PDCCH transmission. Additionally or alternatively, the communication manager 155 may perform one or more other operations described herein.

FIG. 2 is a diagram illustrating an example disaggregated network node architecture 200 in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

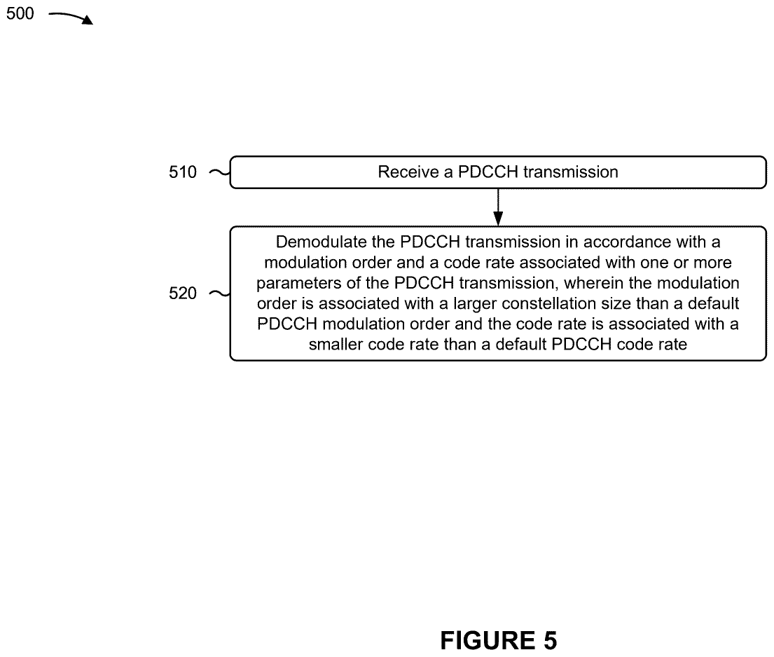

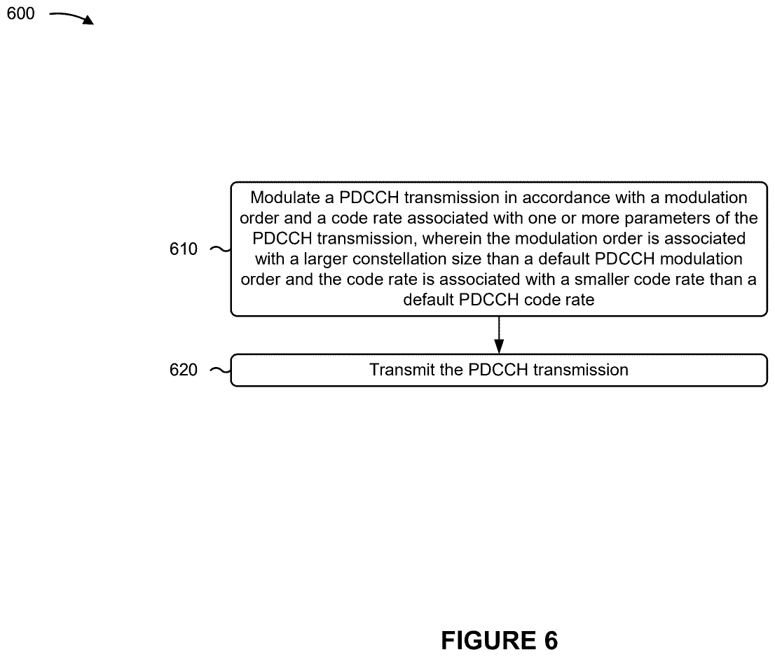

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with modulations switching for PDCCH, as described in more detail elsewhere herein. For example, the processing system 145 of the network node 110, the processing system 140 of the UE 120, the CU 210, the DU 230, or the RU 240 may perform or direct operations of, for example, process 500 of FIG. 5, process 600 of FIG. 6, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 500 of FIG. 5, process 600 of FIG. 6, or other processes as described herein. In some examples, executing instructions may include running the instructions, converting the instructions, compiling the instructions, and/or interpreting the instructions, among other examples.

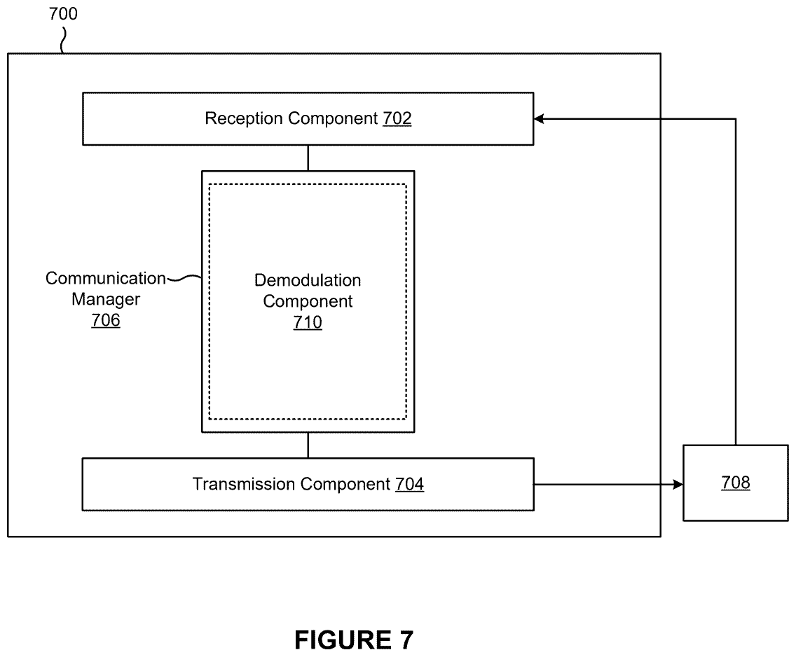

In some aspects, the UE 120 includes means for receiving a PDCCH transmission; and/or means for demodulating the PDCCH transmission in accordance with a modulation order and a code rate associated with one or more parameters of the PDCCH transmission, wherein the modulation order is associated with a larger constellation size than a default PDCCH modulation order and the code rate is associated with a smaller code rate than a default PDCCH code rate. The means for the UE 120 to perform operations described herein may include, for example, one or more of communication manager 150, processing system 140, a radio, one or more RF chains, one or more transceivers, one or more antennas, one or more modems, a reception component (for example, reception component 702 depicted and described in connection with FIG. 7), and/or a transmission component (for example, transmission component 704 depicted and described in connection with FIG. 7), among other examples.

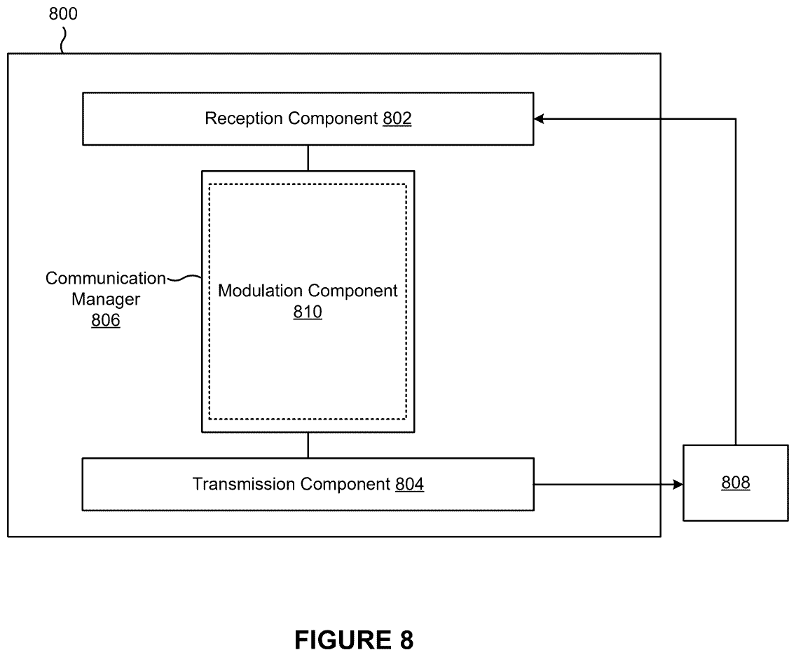

In some aspects, the network node 110 includes means for modulating a PDCCH transmission in accordance with a modulation order and a code rate associated with one or more parameters of the PDCCH transmission, wherein the modulation order is associated with a larger constellation size than a default PDCCH modulation order and the code rate is associated with a smaller code rate than a default PDCCH code rate; and/or means for transmitting the PDCCH transmission. The means for the network node 110 to perform operations described herein may include, for example, one or more of communication manager 155, processing system 145, a radio, one or more RF chains, one or more transceivers, one or more antennas, one or more modems, a reception component (for example, reception component 802 depicted and described in connection with FIG. 8), and/or a transmission component (for example, transmission component 804 depicted and described in connection with FIG. 8), among other examples.

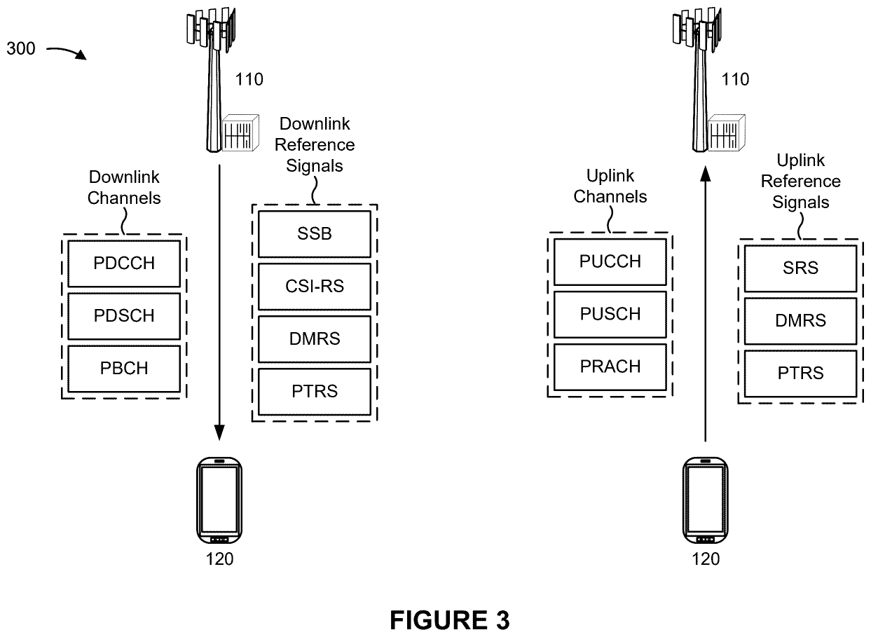

FIG. 3 is a diagram illustrating an example 300 of physical channels and reference signals in a wireless network, in accordance with the present disclosure. As shown in FIG. 3, downlink channels and downlink reference signals may carry information from a network node 110 to a UE 120, and uplink channels and uplink reference signals may carry information from a UE 120 to a network node 110.

As shown, a downlink channel may include a PDCCH that carries downlink control information (DCI), a physical downlink shared channel (PDSCH) that carries downlink data, or a physical broadcast channel (PBCH) that carries system information, among other examples. In some aspects, PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a physical random access channel (PRACH) used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH and/or the PUSCH.

As further shown, a downlink reference signal may include a synchronization signal block (SSB), a channel state information (CSI) reference signal (CSI-RS), a demodulation reference signal (DMRS), a positioning reference signal (PRS), or a phase tracking reference signal (PTRS), among other examples. As also shown, an uplink reference signal may include a sounding reference signal (SRS), a DMRS, or a PTRS, among other examples.

An SSB may carry information used for initial network acquisition and synchronization, such as a primary synchronization signal (PSS), a secondary synchronization signal (SSS), a PBCH, and a PBCH DMRS. An SSB is sometimes referred to as a synchronization signal/PBCH (SS/PBCH) block. In some aspects, the network node 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The network node 110 may configure a set of CSI-RSs for the UE 120, and the UE 120 may measure the configured set of CSI-RSs. Based at least in part on the measurements, the UE 120 may perform channel estimation and may report channel estimation parameters to the network node 110 (e.g., in a CSI report), such as a channel quality indicator (CQI), a precoding matrix indicator (PMI), a CSI-RS resource indicator (CRI), a layer indicator (LI), a rank indicator (RI), or a reference signal received power (RSRP), among other examples. The network node 110 may use the CSI report to select transmission parameters for downlink communications to the UE 120, such as a number of transmission layers (e.g., a rank), a precoding matrix (e.g., a precoder), a modulation and coding scheme (MCS), or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on or otherwise associated with signals transmitted by the network node 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring network nodes in order to perform OTDOA-based positioning. Accordingly, the UE 120 may receive a PRS from multiple cells (e.g., a reference cell and one or more neighbor cells), and may report a reference signal time difference (RSTD) based on or otherwise associated with OTDOA measurements associated with the PRSs received from the multiple cells. In some aspects, the network node 110 may then calculate a position of the UE 120 based on or otherwise associated with the RSTD measurements reported by the UE 120.

An SRS may carry information used for uplink channel estimation, which may be used for scheduling, link adaptation, precoder selection, or beam management, among other examples. The network node 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The network node 110 may measure the SRSs, may perform channel estimation based at least in part on the measurements, and may use the SRS measurements to configure communications with the UE 120.

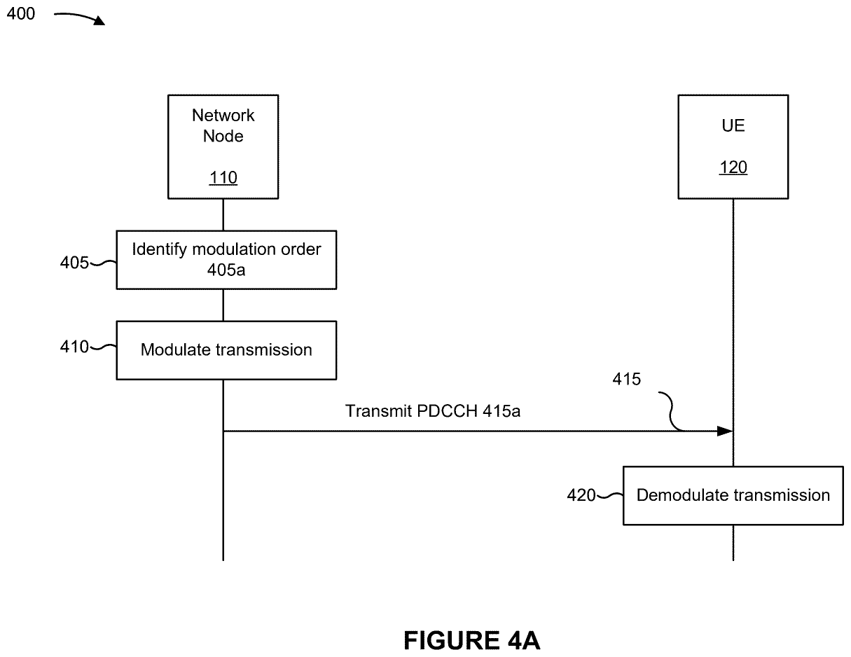

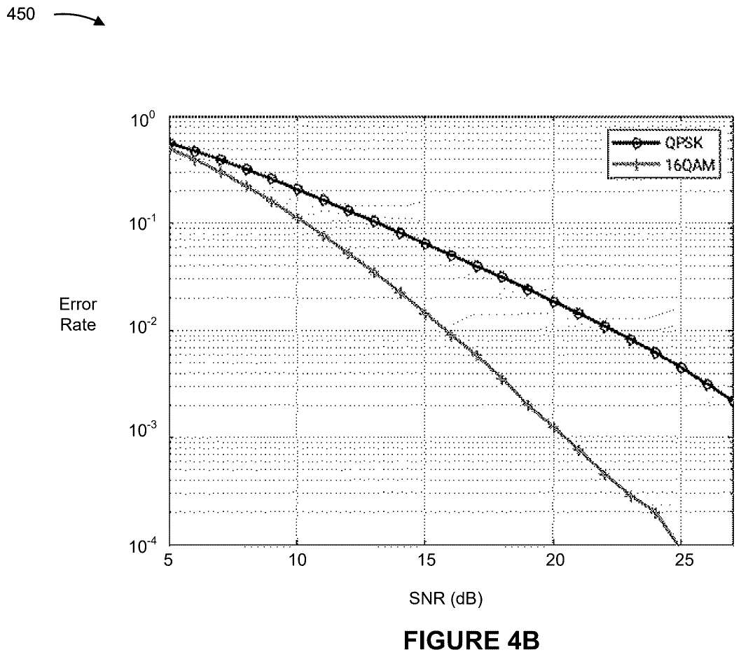

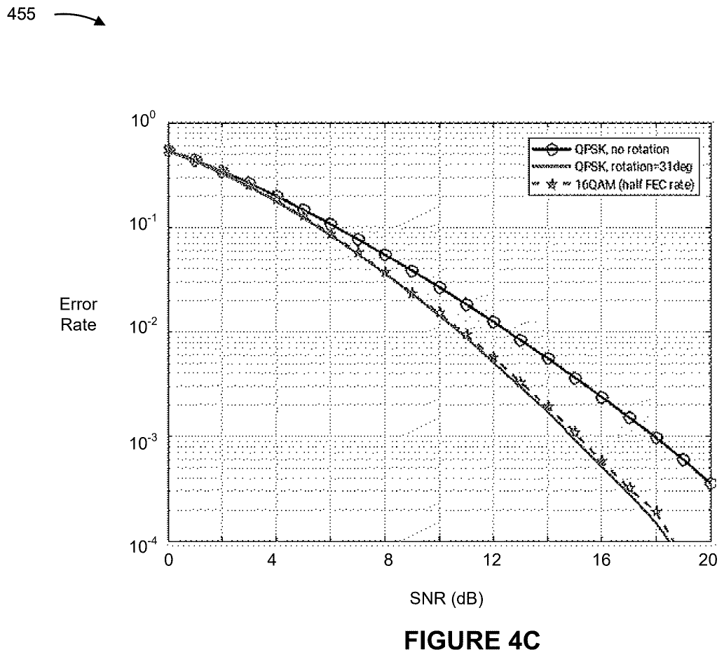

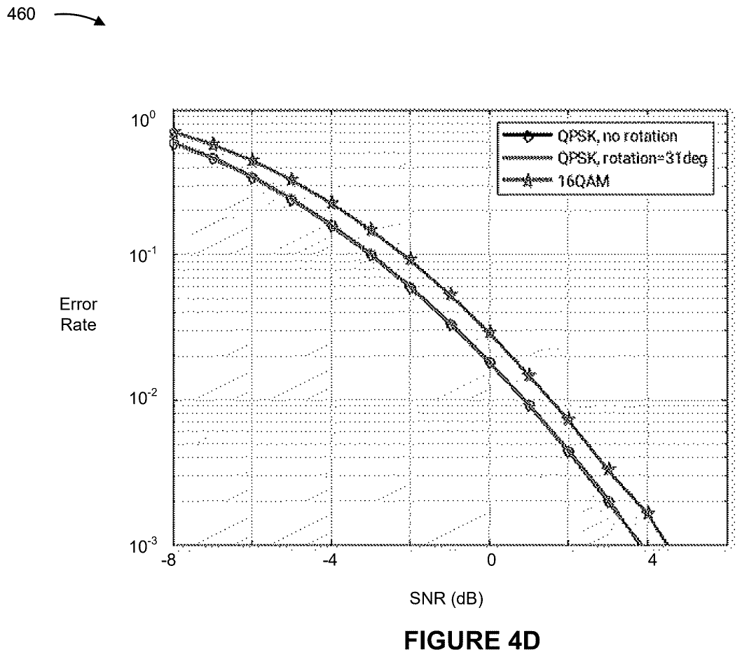

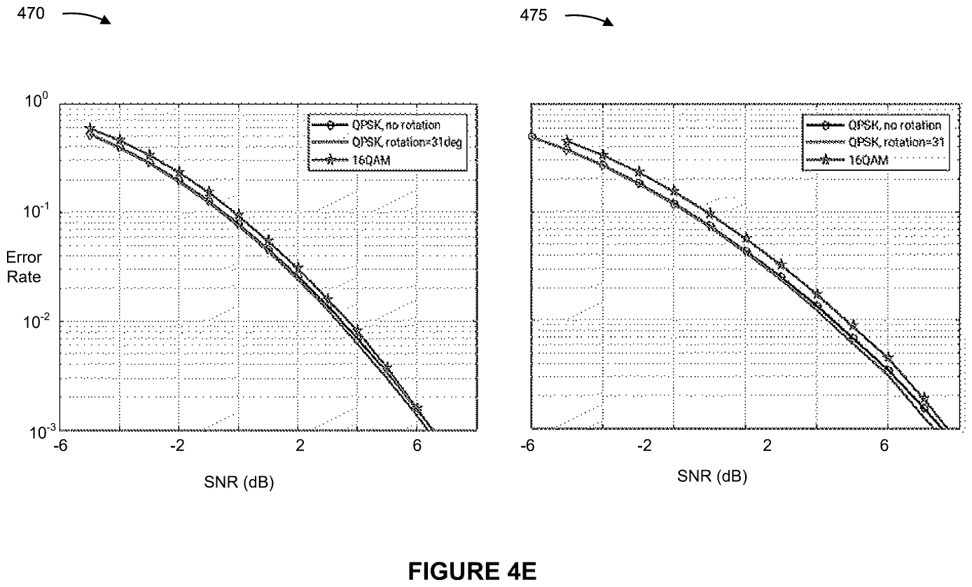

FIGS. 4A-4E are diagrams illustrating an example 400 associated with modulation switching for PDCCH, in accordance with the present disclosure. As shown in FIG. 4A, example 400 includes communication between a network node 110 and a UE 120.

As further shown in FIG. 4A, and in a first operation 405, the network node 110 may identify a modulation order 405a. For example, the network node 110 may identify a modulation type with which to modulate and transmit a PDCCH communication. In some aspects, the network node 110 may identify a modulation order 405a that is different from a default modulation scheme. For example, the network node 110 may identify a modulation type, such as n-ary QAM (8-QAM, 16-QAM, or 32-QAM, among other examples), that is associated with a larger constellation size than a default constellation size that is associated with a default modulation type, such as QPSK. Similarly, the network node 110 may identify a modulation value, such as 32-QAM, that is larger than a default modulation value, such as 8-QAM.

Additionally or alternatively, the network node 110 may identify a modulation order 405a with a different code rate than a default code rate. For example, the network node 110 may identify a code rate, such as a code rate of R/2, that is smaller than a default code rate, such as a code rate of R. In some aspects, the network node 110 may select the modulation order 405a in connection with the code rate. For example, the network node 110 may select, for PDCCH transmission, a larger constellation size modulation order and a smaller code rate. In this example, the network node 110 may, when a default configuration is to use QPSK modulation with a code rate of R, identify a modulation order 405a of 16-QAM with a code rate of R/2. Alternatively, to maintain a constant amplitude with QPSK, the network node 110 may select 8-PSK with a code rate of 2R/3.

In some aspects, the network node 110 may identify a modulation order 405a for PDCCH in connection with one or more parameters. For example, the network node 110 may identify a set of channel metrics, such as a channel delay spread, and may select the modulation order 405a in association with the set of channel metrics. Additionally or alternatively, the network node 110 may select the modulation order 405a in connection with a size of a DCI message that is to be conveyed in the PDCCH transmission, an aggregation level for the PDCCH transmission, a quantity of antennas (for transmission of the PDCCH transmission by the network node 110 or reception of the PDCCH transmission by the UE 120), or another factor. For example, in a frequency diversity limited scenario, such as when using a high coding rate (for a relatively medium or large sized DCI), when using a low aggregation level, when using a low or moderate frequency selectivity, or when communicating with a small quantity of transmit or receive antennas, the network node 110 may select a higher modulation order.

In some aspects, the network node 110 may identify a modulation order 405a based on or otherwise associated with a configuration. For example, the network node 110 may identify a modulation order 405a corresponding to a control resource set (CORESET) that is to be used for communication with the UE 120. Additionally or alternatively, the network node 110 may identify the modulation order 405a in connection with a search space or search space type for the UE 120 to use to receive a PDCCH from the network node 110. For example, the network node 110 may select 16-QAM modulation for use with a UE-specific search space, and may select QPSK modulation for use with a common search space. Additionally or alternatively, the network node 110 may identify the modulation order 405a in connection with a DCI format. For example, the network node 110 may use 16-QAM modulation for transmitting a unicast type of DCI, and may use QPSK modulation for transmitting a group-common type of DCI (or vice versa). Additionally or alternatively, the network node 110 may identify the modulation order 405a in connection with a UE capability. For example, the network node 110 may receive a UE capability indicator, such as an identification of a chest bundling size, and the network node 110 may select a modulation order in connection with a content of the UE capability indicator.

In some aspects, the network node 110 may identify a modulation order 405a in connection with a blind decoding factor. For example, to limit a quantity of blind detections at the UE 120, which may relate to decoding performance and UE resource utilization, the network node 110 may configure a quantity of control channel elements (CCEs) to use for PDCCH candidates in connection with a modulation order. In other words, the network node 110 may configure k1 CCEs for PDCCH candidates with QPSK modulation and k2 CCEs for PDCCH candidates with 16-QAM modulation. In such an example, the network node 110 may select a value for k1 and/or k2, such that a threshold is not exceeded to ensure that demodulation complexity does not exceed a UE capability. For example, when transmitting signals associated with both QPSK CCEs and 16-QAM CCEs, the network node 110 may determine whether k1+(4×k2) exceeds a threshold. In this example, the network node 110 may double count overlapped CCEs (e.g., for PDCCH candidates with both QPSK modulation and 16-QAM modulation) to account for two different types of demodulation being used on such overlapped CCEs.

In some aspects, the network node 110 may identify a modulation order 405a (and associated code rate) based on or otherwise associated with a mapping. For example, the network node 110 may map an aggregation level to a modulation order, such as using 16-QAM for aggregation levels less than or equal to 4 and QPSK for aggregation levels greater than or equal to 8. In another example, the network node 110 may map a modulation order to a plurality of factors, such as selecting 16-QAM in a case when an aggregation level is greater than 8, a DCI size is greater than 50 bits, and a quantity of receive antennas is less than or equal to 2 and selecting QPSK in other cases.

In some aspects, the network node 110 may configure one or more parameters relating to identification of a modulation order or associated code rate. For example, the network node 110 may configure an aggregation level threshold for switching between a default modulation order (QPSK) and a higher modulation order (16-QAM or 8-PSK, among other examples). In this example, the network node 110 may indicate the aggregation level threshold to the UE 120 in, for example, a radio resource control (RRC) message, a system information block (SIB) message, or a medium access control (MAC) control element (CE) message, among other examples. Additionally or alternatively, the network node 110 may indicate the aggregation level threshold (or another parameter for modulation order switching) in connection with a control resource set (CORESET) configuration message, a search space configuration message, or another type of configuration message.

In some aspects, the network node 110 may identify a maximum coded length for PDCCH candidates in connection with identifying a modulation order. For example, to maintain the same decoding overhead between a default modulation order (QPSK) and a higher modulation order (16-QAM or 8-PSK), the network node 110 may set a maximum coded length for PDCCH candidates of the higher modulation order the same as for the default modulation order. To achieve the same maximum coded length for higher modulation orders, the network node may use repetition to lower a spectral efficiency of a higher modulation order to a spectral efficiency of a default modulation order. For example, the network node 110 may identify a modulation order 405a of 16-QAM with a code rate of R and may use different bit to constellation mappings for two copies of the 16-QAM transmission to increase signal space diversity and cause the 16-QAM transmission with a code rate of R mapped to N/2 REs to have a same spectral efficiency as a QPSK transmission with a code rate of R mapped to N REs. In this example, the network node 110 maps bits of the 16-QAM transmission over a first N/2 REs and uses a reversed bit mapping for bits of the 16-QAM transmission of a second N/2 REs to fill the same N REs as is used with the QPSK transmission.

As further shown in FIG. 4A, and in a second operation 410, the network node 110 may modulate a transmission. For example, the network node 110 may modulate a PDCCH communication using the identified modulation order. In some aspects, the network node 110 may modulate the PDCCH communication using a modulation order and a code rate. For example, the network node 110 may modulate the PDCCH communication using a modulation order that is higher than a default modulation order (such as 16-QAM relative to a default modulation order of QPSK) and a code rate that is lower than a default code rate (such as a code rate of R/2 relative to a default coder rate of R). In some aspects, the network node 110 may modulate repetitions of a PDCCH communication. For example, as described above, to reduce an effective spectral efficiency of a higher modulation order PDCCH communication, such that there is a match with a default modulation order PDCCH communication, the network node 110 may modulate a plurality of repetitions of the PDCCH communication. Although some aspects are described herein in terms of a default modulation order of QPSK and a higher modulation order of 16-QAM, it is contemplated that other default modulation orders and higher modulation orders are possible.

As further shown in FIG. 4A, and in a third operation 415, the network node 110 may transmit a PDCCH communication 415a. For example, the network node 110 may transmit, and the UE 120 may receive, a PDCCH communication 415a modulated using the identified modulation order 405a. In some aspects, the UE 120 may receive the PDCCH communication 415a by monitoring a search space. For example, the UE 120 may monitor a UE-specific search space or a group-common search space to receive the PDCCH communication 415a. In this example, the UE 120 may perform blind decoding to attempt to decode the PDCCH communication 415a in a search space.

As further shown in FIG. 4A, and in a fourth operation 420, the UE 120 may demodulate the transmission. For example, the UE 120 may demodulate and decode the received PDCCH communication 415a. In some aspects, the UE 120 may demodulate and decode the received PDCCH communication 415a based on or otherwise associated with a configuration. For example, the UE 120 may receive configuration information that indicates at least one condition or factor for using a modulation order, such as a correspondence between a search space type and a modulation order. In this example, the UE 120 may use the configuration information to attempt to decode the PDCCH communication 415a. In other words, when the UE 120 receives configuration information indicating that 16-QAM is to be used for a UE-specific search space, and when the UE 120 is attempting to receive and decode a PDCCH communication 415a in the UE-specific search space, the UE 120 may use a 16-QAM type of demodulation to decode the PDCCH communication 415a. Similarly, when the UE 120 receives configuration information indicating that a higher modulation order (relative to a default modulation order) and a lower code rate (relative to a default code rate) is to be used with a particular aggregation level or quantity of receive antennas, as described above, the UE 120 may use the higher modulation order and lower code rate for demodulation when the particular aggregation level or quantity of receive antennas is being used (and the default modulation order and default code rate when the particular aggregation level or quantity of receive antennas is not being used).

FIG. 4B shows an example 450 of a signal to noise ratio (SNR) values at different error rates for the UE 120 attempting to decode a PDCCH communication with different modulation orders for an aggregation level (AL) of AL=1. As shown in FIG. 4B, at a block error rate (BLER) of 10⁻², 16-QAM has a 6 decibel (dB) gain in SNR relative to a QPSK modulation order. FIG. 4C shows example 455 of an SNR at different error rate values. Here, the network node 110 transmits with 1 transmit antenna and the UE 120 receives with 1 receive antenna. Further, the network node 110 transmits with an aggregation level of AL=2 and with a time domain link adaptation (TDLA) of 30 nanoseconds (ns). Here, in example 455, the network node 110 transmits a QPSK modulated PDCCH communication, a QPSK modulated communication with a 31 degree rotation, and a 16-QAM modulated PDCCH communication with half-rate forward error correction (FEC). As shown in example 455, at a BLER of 10⁻², 16-QAM transmission and 31 degree rotated QPSK transmission each have a 2 dB gain in SNR relative to un-rotated QPSK rotation. In contrast, FIG. 4D shows example 460 of an SNR values and error rates under the same conditions as example 455, except with an aggregation level of AL=8. As shown, in example 460, QPSK modulation (with rotation and without rotation) exhibits SNR gain relative to 16-QAM transmission.

FIG. 4E shows examples 470 and 475 of an effect of different chest bundle sizes on SNR for different modulation orders. For example with an aggregation level of AL=8 and a chest bundle size of 2 resource blocks (RB), in example 470, QPSK (with rotation and without rotation) shows a first level of gain relative to 16-QAM transmission across different error rates. Similarly, in example 475, with an aggregation level of AL=8 and a chest bundle size of 6 RBs, QPSK shows a second level of gain relative to 16-QAM transmission across different error rates.

FIG. 5 is a flowchart illustrating an example process 500 performed, for example, at an UE or an apparatus of an UE that supports modulation switching for PDCCH in accordance with the present disclosure. Example process 500 is an example where the apparatus or the UE (for example, UE 120) performs operations associated with modulation switching for PDCCH.

As shown in FIG. 5, in some aspects, process 500 may include receiving a PDCCH transmission (block 510). For example, the UE (such as by using communication manager 706 or reception component 702, depicted in FIG. 7) may receive a PDCCH transmission, as described above.

As further shown in FIG. 5, in some aspects, process 500 may include demodulating the PDCCH transmission in accordance with a modulation order and a code rate associated with one or more parameters of the PDCCH transmission, wherein the modulation order is associated with a larger constellation size than a default PDCCH modulation order and the code rate is associated with a smaller code rate than a default PDCCH code rate (block 520). For example, the UE (such as by using communication manager 706 or demodulation component 710, depicted in FIG. 7) may demodulate the PDCCH transmission in accordance with a modulation order and a code rate associated with one or more parameters of the PDCCH transmission, wherein the modulation order is associated with a larger constellation size than a default PDCCH modulation order and the code rate is associated with a smaller code rate than a default PDCCH code rate, as described above.

Process 500 may include additional aspects, such as any single aspect or any combination of aspects described below or in connection with one or more other processes described elsewhere herein.

In a first additional aspect, the one or more parameters include at least one of a DCI size, an aggregation level, a receiving antenna quantity, or a channel delay spread value.

In a second additional aspect, alone or in combination with the first aspect, the modulation order is associated with at least one of a CORESET a search space, a search space type, a DCI format, or a UE decoding capability.

In a third additional aspect, alone or in combination with one or more of the first and second aspects, process 500 includes receiving configuration information that indicates at least one condition for using the modulation order.

In a fourth additional aspect, alone or in combination with one or more of the first through third aspects, the at least one condition is indicated in accordance with a CORESET configuration.

In a fifth additional aspect, alone or in combination with one or more of the first through fourth aspects, the at least one condition is indicated in accordance with a search space configuration.

In a sixth additional aspect, alone or in combination with one or more of the first through fifth aspects, the PDCCH transmission has a coded length that does not exceed a maximum coded length associated with the default PDCCH modulation order.

In a seventh additional aspect, alone or in combination with one or more of the first through sixth aspects, the default PDCCH modulation order is associated with QPSK.

In an eighth additional aspect, alone or in combination with one or more of the first through seventh aspects, process 500 includes receiving a repetition of the PDCCH transmission, wherein the PDCCH transmission includes a first set of REs associated with a first bit mapping configuration and the repetition of the PDCCH transmission includes a second set of REs associated with a second bit mapping configuration.

In a ninth additional aspect, alone or in combination with one or more of the first through eighth aspects, demodulating the PDCCH transmission includes demodulating the PDCCH transmission in accordance with at least one blind detection limit associated with a quantity of CCEs, wherein each CCE of the quantity of CCEs is associated with at least one blind decoding weight.

In a tenth additional aspect, alone or in combination with one or more of the first through ninth aspects, the quantity of CCEs includes a first set of CCEs associated with the modulation order and a second set of CCEs associated with the default PDCCH modulation order.

In an eleventh additional aspect, alone or in combination with one or more of the first through tenth aspects, each blind decoding weight of the at least one blind decoding weight is associated with either the modulation order or the default PDCCH modulation order.

In a twelfth additional aspect, alone or in combination with one or more of the first through eleventh aspects, demodulating the PDCCH transmission includes demodulating the PDCCH transmission in accordance with the default PDCCH modulation order in accordance with the PDCCH transmission having at least two overlapping CCEs associated with the modulation order and the default PDCCH modulation order.

Although FIG. 5 shows example blocks of process 500, in some aspects, process 500 may include additional blocks, fewer blocks, different blocks, or differently arranged blocks than those depicted in FIG. 5. Additionally or alternatively, two or more of the blocks of process 500 may be performed in parallel.

FIG. 6 is a flowchart illustrating an example process 600 performed, for example, at a network node or an apparatus of a network node that supports modulation switching for PDCCH in accordance with the present disclosure. Example process 600 is an example where the apparatus or the network node (for example, network node 110) performs operations associated with modulation switching for PDCCH.

As shown in FIG. 6, in some aspects, process 600 may include modulating a PDCCH transmission in accordance with a modulation order and a code rate associated with one or more parameters of the PDCCH transmission, wherein the modulation order is associated with a larger constellation size than a default PDCCH modulation order and the code rate is associated with a smaller code rate than a default PDCCH code rate (block 610). For example, the network node (such as by using communication manager 806 or modulation component 810, depicted in FIG. 8) may modulate a PDCCH transmission in accordance with a modulation order and a code rate associated with one or more parameters of the PDCCH transmission, wherein the modulation order is associated with a larger constellation size than a default PDCCH modulation order and the code rate is associated with a smaller code rate than a default PDCCH code rate, as described above.

As further shown in FIG. 6, in some aspects, process 600 may include transmitting the PDCCH transmission (block 620). For example, the network node (such as by using communication manager 806 or transmission component 804, depicted in FIG. 8) may transmit the PDCCH transmission, as described above.

Process 600 may include additional aspects, such as any single aspect or any combination of aspects described below or in connection with one or more other processes described elsewhere herein.

In a first additional aspect, the one or more parameters include at least one of a DCI size, an aggregation level, a receiving antenna quantity, or a channel delay spread value.

In a second additional aspect, alone or in combination with the first aspect, the modulation order is associated with at least one of a CORESET, a search space, a search space type, a DCI format, or a UE decoding capability.

In a third additional aspect, alone or in combination with one or more of the first and second aspects, process 600 includes transmitting configuration information that indicates at least one condition for using the modulation order.

In a fourth additional aspect, alone or in combination with one or more of the first through third aspects, the at least one condition is indicated in accordance with a CORESET configuration.

In a fifth additional aspect, alone or in combination with one or more of the first through fourth aspects, the at least one condition is indicated in accordance with a search space configuration.

In a sixth additional aspect, alone or in combination with one or more of the first through fifth aspects, the PDCCH transmission has a coded length that does not exceed a maximum coded length associated with the default PDCCH modulation order.

In a seventh additional aspect, alone or in combination with one or more of the first through sixth aspects, the default PDCCH modulation order is associated with QPSK.

In an eighth additional aspect, alone or in combination with one or more of the first through seventh aspects, process 600 includes transmitting a repetition of the PDCCH transmission, wherein the PDCCH transmission includes a first set of REs associated with a first bit mapping configuration and the repetition of the PDCCH transmission includes a second set of REs associated with a second bit mapping configuration.

In a ninth additional aspect, alone or in combination with one or more of the first through eighth aspects, modulating the PDCCH transmission includes modulating the PDCCH transmission in accordance with at least one blind detection limit associated with a quantity of CCEs, wherein each CCE of the quantity of CCEs is associated with at least one blind decoding weight.

In a tenth additional aspect, alone or in combination with one or more of the first through ninth aspects, the quantity of CCEs includes a first set of CCEs associated with the modulation order and a second set of CCEs associated with the default PDCCH modulation order.

In an eleventh additional aspect, alone or in combination with one or more of the first through tenth aspects, each blind decoding weight of the at least one blind decoding weight is associated with either the modulation order or the default PDCCH modulation order.

In a twelfth additional aspect, alone or in combination with one or more of the first through eleventh aspects, modulating includes modulating the PDCCH transmission in accordance with the default PDCCH modulation order in accordance with the PDCCH transmission having at least two overlapping CCEs associated with the modulation order and the default PDCCH modulation order.

Although FIG. 6 shows example blocks of process 600, in some aspects, process 600 may include additional blocks, fewer blocks, different blocks, or differently arranged blocks than those depicted in FIG. 6. Additionally or alternatively, two or more of the blocks of process 600 may be performed in parallel.

FIG. 7 is a diagram of an example apparatus 700 for wireless communication that supports modulation switching for PDCCH in accordance with the present disclosure. The apparatus 700 may be a UE, or a UE may include the apparatus 700. In some aspects, the apparatus 700 includes a reception component 702, a transmission component 704, and a communication manager 706, which may be in communication with one another (for example, via one or more buses). As shown, the apparatus 700 may communicate with another apparatus 708 (such as a UE 120, a network node 110, or another wireless communication device) using the reception component 702 and the transmission component 704. The communication manager 706 may be included in, or implemented via, a processing system (for example, the processing system 140). In some aspects, the communication manager 706 is the communication manager 150.

In some aspects, the apparatus 700 may be configured to and/or operable to perform one or more operations described herein in connection with FIGS. 4A-4E. Additionally or alternatively, the apparatus 700 may be configured to and/or operable to perform one or more processes described herein, such as process 500 of FIG. 5.

The reception component 702 may receive communications, such as reference signals, control information, and/or data communications, from the apparatus 708. The reception component 702 may provide received communications to one or more other components of the apparatus 700, such as the communication manager 706. In some aspects, the reception component 702 may perform signal processing on the received communications, and may provide the processed signals to the one or more other components in a similar manner as described above in connection with FIG. 1. In some aspects, the reception component 702 may include one or more components of the UE described above in connection with FIG. 1, such as a radio, one or more RF chains, one or more transceivers, or one or more modems, each of which may in turn be coupled with one or more antennas of the UE.

The transmission component 704 may transmit communications, such as reference signals, control information, and/or data communications, to the apparatus 708. In some aspects, the communication manager 706 may generate communications and may transmit the generated communications to the transmission component 704 for transmission to the apparatus 708. In some aspects, the transmission component 704 may perform signal processing on the generated communications, and may transmit the processed signals to the apparatus 708 in a similar manner as described above in connection with FIG. 1. In some aspects, the transmission component 704 may include one or more components of the UE described above in connection with FIG. 1, such as a radio, one or more RF chains, one or more transceivers, or one or more modems, each of which may in turn be coupled with one or more antennas of the UE. In some aspects, the transmission component 704 may be co-located with the reception component 702.

The communication manager 706 may receive or may cause the reception component 702 to receive a PDCCH transmission. The communication manager 706 may demodulate the PDCCH transmission in accordance with a modulation order and a code rate associated with one or more parameters of the PDCCH transmission, wherein the modulation order is associated with a larger constellation size than a default PDCCH modulation order and the code rate is associated with a smaller code rate than a default PDCCH code rate. In some aspects, the communication manager 706 may perform one or more operations described elsewhere herein as being performed by one or more components of the communication manager 06.

In some aspects, the communication manager 706 includes a set of components, such as a demodulation component 710. Alternatively, the set of components may be separate and distinct from the communication manager 706. As used herein, the term “component” is intended to be broadly construed as hardware or a combination of hardware and at least one of software or firmware. In some aspects, one or more components of the set of components may include or may be implemented within a processing system (for example, the processing system 140). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The reception component 702 may receive a PDCCH transmission. The demodulation component 710 may demodulate the PDCCH transmission in accordance with a modulation order and a code rate associated with one or more parameters of the PDCCH transmission, wherein the modulation order is associated with a larger constellation size than a default PDCCH modulation order and the code rate is associated with a smaller code rate than a default PDCCH code rate. The reception component 702 may receive configuration information that indicates at least one condition for using the modulation order. The reception component 702 may receive a repetition of the PDCCH transmission, wherein the PDCCH transmission includes a first set of REs associated with a first bit mapping configuration and the repetition of the PDCCH transmission includes a second set of REs associated with a second bit mapping configuration.

The quantity and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally or alternatively, a set of (one or more) components shown in FIG. 7 may perform one or more functions described as being performed by another set of components shown in FIG. 7.

FIG. 8 is a diagram of an example apparatus 800 for wireless communication that supports modulation switching for PDCCH in accordance with the present disclosure. The apparatus 800 may be a network node, or a network node may include the apparatus 800. In some aspects, the apparatus 800 includes a reception component 802, a transmission component 804, and a communication manager 806, which may be in communication with one another (for example, via one or more buses). As shown, the apparatus 800 may communicate with another apparatus 808 (such as a UE 120, a network node 110, or another wireless communication device) using the reception component 802 and the transmission component 804. The communication manager 806 may be included in, or implemented via, a processing system (for example, the processing system 145) In some aspects, the communication manager 806 is the communication manager 155.

In some aspects, the apparatus 800 may be configured to and/or operable to perform one or more operations described herein in connection with FIGS. 4A-4E. Additionally or alternatively, the apparatus 800 may be configured to and/or operable to perform one or more processes described herein, such as process 600 of FIG. 6.

The reception component 802 may receive communications, such as reference signals, control information, and/or data communications, from the apparatus 808. The reception component 802 may provide received communications to one or more other components of the apparatus 800, such as the communication manager 806. In some aspects, the reception component 802 may perform signal processing on the received communications, and may provide the processed signals to the one or more other components in a similar manner as described above in connection with FIG. 1. In some aspects, the reception component 802 may include one or more components of the network node described above in connection with FIG. 1, such as a radio, one or more RF chains, one or more transceivers, or one or more modems, each of which may in turn be coupled with one or more antennas of the network node.

The transmission component 804 may transmit communications, such as reference signals, control information, and/or data communications, to the apparatus 808. In some aspects, the communication manager 806 may generate communications and may transmit the generated communications to the transmission component 804 for transmission to the apparatus 808. In some aspects, the transmission component 804 may perform signal processing on the generated communications, and may transmit the processed signals to the apparatus 808 in a similar manner as described above in connection with FIG. 1. In some aspects, the transmission component 804 may include one or more components of the network node described above in connection with FIG. 1, such as a radio, one or more RF chains, one or more transceivers, or one or more modems, each of which may in turn be coupled with one or more antennas of the network node. In some aspects, the transmission component 804 may be co-located with the reception component 802.

The communication manager 806 may modulate a PDCCH transmission in accordance with a modulation order and a code rate associated with one or more parameters of the PDCCH transmission, wherein the modulation order is associated with a larger constellation size than a default PDCCH modulation order and the code rate is associated with a smaller code rate than a default PDCCH code rate. The communication manager 806 may transmit or may cause the transmission component 804 to transmit the PDCCH transmission. In some aspects, the communication manager 06 may perform one or more operations described elsewhere herein as being performed by one or more components of the communication manager 806.

In some aspects, the communication manager 806 includes a set of components, such as a modulation component 810. Alternatively, the set of components may be separate and distinct from the communication manager 806. As used herein, the term “component” is intended to be broadly construed as hardware or a combination of hardware and at least one of software or firmware. In some aspects, one or more components of the set of components may include or may be implemented within a processing system (for example, the processing system 145). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The modulation component 810 may modulate a PDCCH transmission in accordance with a modulation order and a code rate associated with one or more parameters of the PDCCH transmission, wherein the modulation order is associated with a larger constellation size than a default PDCCH modulation order and the code rate is associated with a smaller code rate than a default PDCCH code rate. The transmission component 804 may transmit the PDCCH transmission. The transmission component 804 may transmit configuration information that indicates at least one condition for using the modulation order. The transmission component 804 may transmit a repetition of the PDCCH transmission, wherein the PDCCH transmission includes a first set of REs associated with a first bit mapping configuration and the repetition of the PDCCH transmission includes a second set of REs associated with a second bit mapping configuration.

The quantity and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally or alternatively, a set of (one or more) components shown in FIG. 8 may perform one or more functions described as being performed by another set of components shown in FIG. 8.

The following provides an overview of some Aspects of the present disclosure:
Aspect 1: A method for wireless communication by a user equipment (UE), comprising: receiving a physical downlink control channel (PDCCH) transmission; and demodulating the PDCCH transmission in accordance with a modulation order and a code rate associated with one or more parameters of the PDCCH transmission, wherein the modulation order is associated with a larger constellation size than a default PDCCH modulation order and the code rate is associated with a smaller code rate than a default PDCCH code rate.
Aspect 2: The method of Aspect 1, wherein the one or more parameters include at least one of a downlink control information (DCI) size, an aggregation level, a receiving antenna quantity, or a channel delay spread value.
Aspect 3: The method of any of Aspects 1-2, wherein the modulation order is associated with at least one of a control resource set (CORESET), a search space, a search space type, a downlink control information (DCI) format, or a UE decoding capability.
Aspect 4: The method of any of Aspects 1-3, further comprising: receiving configuration information that indicates at least one condition for using the modulation order.
Aspect 5: The method of Aspect 4, wherein the at least one condition is indicated in accordance with a control resource set (CORESET) configuration.
Aspect 6: The method of Aspect 4, wherein the at least one condition is indicated in accordance with a search space configuration.
Aspect 7: The method of any of Aspects 1-6, wherein the PDCCH transmission has a coded length that does not exceed a maximum coded length associated with the default PDCCH modulation order.
Aspect 8: The method of any of Aspects 1-7, wherein the default PDCCH modulation order is associated with quadrature phase shift keying (QPSK).
Aspect 9: The method of any of Aspects 1-8, further comprising: receiving a repetition of the PDCCH transmission, wherein the PDCCH transmission includes a first set of resource elements (REs) associated with a first bit mapping configuration and the repetition of the PDCCH transmission includes a second set of REs associated with a second bit mapping configuration.
Aspect 10: The method of any of Aspects 1-9, wherein demodulating the PDCCH transmission includes demodulating the PDCCH transmission in accordance with at least one blind detection limit associated with a quantity of control channel elements (CCEs), wherein each CCE of the quantity of CCEs is associated with at least one blind decoding weight.
Aspect 11: The method of Aspect 10, wherein the quantity of CCEs includes a first set of CCEs associated with the modulation order and a second set of CCEs associated with the default PDCCH modulation order.
Aspect 12: The method of Aspect 10, wherein each blind decoding weight of the at least one blind decoding weight is associated with either the modulation order or the default PDCCH modulation order.
Aspect 13: The method of Aspect 12, wherein demodulating the PDCCH transmission includes demodulating the PDCCH transmission in accordance with the default PDCCH modulation order in accordance with the PDCCH transmission having at least two overlapping CCEs associated with the modulation order and the default PDCCH modulation order.
Aspect 14: A method of wireless communication performed by a network node, comprising: modulating a physical downlink control channel (PDCCH) transmission in accordance with a modulation order and a code rate associated with one or more parameters of the PDCCH transmission, wherein the modulation order is associated with a larger constellation size than a default PDCCH modulation order and the code rate is associated with a smaller code rate than a default PDCCH code rate; and transmitting the PDCCH transmission.
Aspect 15: The method of Aspect 14, wherein the one or more parameters include at least one of a downlink control information (DCI) size, an aggregation level, a receiving antenna quantity, or a channel delay spread value.
Aspect 16: The method of any of Aspects 14-15, wherein the modulation order is associated with at least one of a control resource set (CORESET), a search space, a search space type, a downlink control information (DCI) format, or a user equipment (UE) decoding capability.
Aspect 17: The method of any of Aspects 14-16, further comprising: transmitting configuration information that indicates at least one condition for using the modulation order.
Aspect 18: The method of Aspect 17, wherein the at least one condition is indicated in accordance with a control resource set (CORESET) configuration.
Aspect 19: The method of Aspect 17, wherein the at least one condition is indicated in accordance with a search space configuration.
Aspect 20: The method of any of Aspects 14-19, wherein the PDCCH transmission has a coded length that does not exceed a maximum coded length associated with the default PDCCH modulation order.
Aspect 21: The method of any of Aspects 14-20, wherein the default PDCCH modulation order is associated with quadrature phase shift keying (QPSK).
Aspect 22: The method of any of Aspects 14-21, further comprising: transmitting a repetition of the PDCCH transmission, wherein the PDCCH transmission includes a first set of resource elements (REs) associated with a first bit mapping configuration and the repetition of the PDCCH transmission includes a second set of REs associated with a second bit mapping configuration.
Aspect 23: The method of any of Aspects 14-22, wherein modulating the PDCCH transmission includes modulating the PDCCH transmission in accordance with at least one blind detection limit associated with a quantity of control channel elements (CCEs), wherein each CCE of the quantity of CCEs is associated with at least one blind decoding weight.
Aspect 24: The method of Aspect 23, wherein the quantity of CCEs includes a first set of CCEs associated with the modulation order and a second set of CCEs associated with the default PDCCH modulation order.
Aspect 25: The method of Aspect 23, wherein each blind decoding weight of the at least one blind decoding weight is associated with either the modulation order or the default PDCCH modulation order.
Aspect 26: The method of Aspect 25, wherein modulating includes modulating the PDCCH transmission in accordance with the default PDCCH modulation order in accordance with the PDCCH transmission having at least two overlapping CCEs associated with the modulation order and the default PDCCH modulation order.
Aspect 27: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-26.
Aspect 28: An apparatus for wireless communication at a device, the apparatus comprising one or more memories and one or more processors coupled to the one or more memories, the one or more processors configured to cause the device to perform the method of one or more of Aspects 1-26.
Aspect 29: An apparatus for wireless communication, the apparatus comprising at least one means for performing the method of one or more of Aspects 1-26.
Aspect 30: A non-transitory computer-readable medium storing code for wireless communication, the code comprising instructions executable by one or more processors to perform the method of one or more of Aspects 1-26.
Aspect 31: A non-transitory computer-readable medium storing a set of instructions for wireless communication, the set of instructions comprising one or more instructions that, when executed by one or more processors of a device, cause the device to perform the method of one or more of Aspects 1-26.
Aspect 32: A device for wireless communication, the device comprising a processing system that includes one or more processors and one or more memories coupled with the one or more processors, the processing system configured to cause the device to perform the method of one or more of Aspects 1-26.
Aspect 33: An apparatus for wireless communication at a device, the apparatus comprising one or more memories and one or more processors coupled to the one or more memories, the one or more processors individually or collectively configured to cause the device to perform the method of one or more of Aspects 1-26.

The foregoing disclosure provides illustration and description but is not intended to be exhaustive or to limit the aspects to the precise forms disclosed.

Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a +a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
a processing system that includes one or more processors and one or more memories coupled with the one or more processors, the processing system configured to cause the UE to:
receive a physical downlink control channel (PDCCH) transmission; and
demodulate the PDCCH transmission in accordance with a modulation order and a code rate associated with one or more parameters of the PDCCH transmission, wherein the modulation order is associated with a larger constellation size than a default PDCCH modulation order and the code rate is associated with a smaller code rate than a default PDCCH code rate.

2. The UE of claim 1, wherein the one or more parameters include at least one of a downlink control information (DCI) size, an aggregation level, a receiving antenna quantity, or a channel delay spread value.

3. The UE of claim 1, wherein the modulation order is associated with at least one of a control resource set (CORESET), a search space, a search space type, a downlink control information (DCI) format, or a UE decoding capability.

4. The UE of claim 1, wherein the processing system is further configured to cause the UE to:
receive configuration information that indicates at least one condition for using the modulation order.

5. The UE of claim 4, wherein the at least one condition is indicated in accordance with a control resource set (CORESET) configuration.

6. The UE of claim 4, wherein the at least one condition is indicated in accordance with a search space configuration.

7. The UE of claim 1, wherein the PDCCH transmission has a coded length that does not exceed a maximum coded length associated with the default PDCCH modulation order.

8. The UE of claim 1, wherein the default PDCCH modulation order is associated with quadrature phase shift keying (QPSK).

9. The UE of claim 1, wherein the processing system is further configured to cause the UE to:
receive a repetition of the PDCCH transmission, wherein the PDCCH transmission includes a first set of resource elements (REs) associated with a first bit mapping configuration and the repetition of the PDCCH transmission includes a second set of REs associated with a second bit mapping configuration.

10. The UE of claim 1, wherein demodulating the PDCCH transmission includes demodulating the PDCCH transmission in accordance with at least one blind detection limit associated with a quantity of control channel elements (CCEs), wherein each CCE of the quantity of CCEs is associated with at least one blind decoding weight.

11. The UE of claim 10, wherein the quantity of CCEs includes a first set of CCEs associated with the modulation order and a second set of CCEs associated with the default PDCCH modulation order.

12. The UE of claim 10, wherein each blind decoding weight of the at least one blind decoding weight is associated with either the modulation order or the default PDCCH modulation order.

13. The UE of claim 12, wherein, to cause the UE to demodulate the PDCCH transmission, the processing system is configured to cause the UE to demodulate the PDCCH transmission in accordance with the default PDCCH modulation order in accordance with the PDCCH transmission having at least two overlapping CCEs associated with the modulation order and the default PDCCH modulation order.

14. A network node for wireless communication, comprising:
a processing system that includes one or more processors and one or more memories coupled with the one or more processors, the processing system configured to cause the network node to:
modulate a physical downlink control channel (PDCCH) transmission in accordance with a modulation order and a code rate associated with one or more parameters of the PDCCH transmission, wherein the modulation order is associated with a larger constellation size than a default PDCCH modulation order and the code rate is associated with a smaller code rate than a default PDCCH code rate; and
transmit the PDCCH transmission.

15. The network node of claim 14, wherein the one or more parameters include at least one of a downlink control information (DCI) size, an aggregation level, a receiving antenna quantity, or a channel delay spread value.

16. The network node of claim 14, wherein the modulation order is associated with at least one of a control resource set (CORESET), a search space, a search space type, a downlink control information (DCI) format, or a user equipment (UE) decoding capability.

17. The network node of claim 14, wherein the processing system is further configured to cause the network node to:
transmit configuration information that indicates at least one condition for using the modulation order.

18. The network node of claim 17, wherein the at least one condition is indicated in accordance with a control resource set (CORESET) configuration.

19. The network node of claim 17, wherein the at least one condition is indicated in accordance with a search space configuration.

20. The network node of claim 14, wherein the PDCCH transmission has a coded length that does not exceed a maximum coded length associated with the default PDCCH modulation order.

21. The network node of claim 14, wherein the default PDCCH modulation order is associated with quadrature phase shift keying (QPSK).

22. The network node of claim 14, wherein the processing system is further configured to cause the network node to:
transmit a repetition of the PDCCH transmission, wherein the PDCCH transmission includes a first set of resource elements (REs) associated with a first bit mapping configuration and the repetition of the PDCCH transmission includes a second set of REs associated with a second bit mapping configuration.

23. The network node of claim 14, wherein modulating the PDCCH transmission includes modulating the PDCCH transmission in accordance with at least one blind detection limit associated with a quantity of control channel elements (CCEs), wherein each CCE of the quantity of CCEs is associated with at least one blind decoding weight.

24. The network node of claim 23, wherein the quantity of CCEs includes a first set of CCEs associated with the modulation order and a second set of CCEs associated with the default PDCCH modulation order.

25. The network node of claim 23, wherein each blind decoding weight of the at least one blind decoding weight is associated with either the modulation order or the default PDCCH modulation order.

26. The network node of claim 25, wherein, to cause the network node to modulate, the processing system is configured to cause the network node to modulate the PDCCH transmission in accordance with the default PDCCH modulation order in accordance with the PDCCH transmission having at least two overlapping CCEs associated with the modulation order and the default PDCCH modulation order.

27. A method for wireless communication by a user equipment (UE), comprising:
receiving a physical downlink control channel (PDCCH) transmission; and
demodulating the PDCCH transmission in accordance with a modulation order and a code rate associated with one or more parameters of the PDCCH transmission, wherein the modulation order is associated with a larger constellation size than a default PDCCH modulation order and the code rate is associated with a smaller code rate than a default PDCCH code rate.

28. The method of claim 27, wherein the one or more parameters include at least one of a downlink control information (DCI) size, an aggregation level, a receiving antenna quantity, or a channel delay spread value.

29. A method of wireless communication performed by a network node, comprising:
modulating a physical downlink control channel (PDCCH) transmission in accordance with a modulation order and a code rate associated with one or more parameters of the PDCCH transmission, wherein the modulation order is associated with a larger constellation size than a default PDCCH modulation order and the code rate is associated with a smaller code rate than a default PDCCH code rate; and
transmitting the PDCCH transmission.

30. The method of claim 29, wherein the one or more parameters include at least one of a downlink control information (DCI) size, an aggregation level, a receiving antenna quantity, or a channel delay spread value.
